(19) United States
(12) Patent Application Publication
(10) Pub. No.: US 2005/0021674 A1
(43) Pub. Date: Jan. 27, 2005

(54) Method for transferring a page from a server to a client, a program suitable to carry out the method, and the use thereof

(76) Inventors: Jacobus Martinus Kruithof, Breda (NL); Gerrit Cornelis Blom, Sprang-Capelle (NL)

Correspondence Address: John C Han;Ericsson, 6300 Legacy Drive, M/S EVW 2-C-2, Plano, TX, 75024, US

(21) Appl. No.: 10/478,729

(22) PCT Filed: May 30, 2001
(86) PCT No.: PCT/NL01/00419

(51) Int. Cl. G06F 15/16

(52) U.S. Cl. 709/218

(57) ABSTRACT

A method for transferring a page to a client which is coupled to a first server wherein the page comprises at least one request for a page element. The method comprises the step of collecting the page in the first server, in response to a request for transferring the page to the client, and the further steps carried out in the first server of: deriving from the page the at least one request for the page element; collecting the at least one page element, in response to the at least one request for the page element derived from the page; combining the at least one page element with the page; and transferring the page with the collected at least one page element to the client.

The invention relates to a method for transferring a page to a client which is coupled to a first server, the page comprising at least one request for a page element, the method comprising the step of collecting the page in the first server, in response to a request for transferring the page to the client. Further, the invention relates to a computer program, a server, and a client. Still further, the invention relates to a use of a client and a use of a server.

Servers, such as proxy servers, for transferring a page, such as an internet page to a client are commonly used. A server can be coupled to a network of computers, such as the internet, allowing the client to obtain access to the computers coupled to the network. Alternatively, the server can be a stand alone computer, which contains a number of pages which can be accessed by the client. When the client sends a request for a page, this request is received by the server. The server collects the page, which can take place by sending a request for the page to another server, which sends the page back to the server, or by collecting the page from a memory coupled to the server. Then, the page is transmitted from the server to the client. Frequently, the internet page contains page elements, such as pictures, scripts, sound files, video, or other elements. Upon receipt of the page by the client, the client interprets the page and detects requests (or links or references) for such page elements in the page. The client sends a request for each of the page elements to the server. The server attempts to collect each page element, by sending a request to another server containing the page element, or by collecting the page element from a memory coupled to the server. Each page element is, when collected by the server, transmitted from the server to the client. Upon receipt of a page element by the client, the client can integrate the page element with the page. In this way, when the client requests for a page, first the page is collected and sent to the client, followed by a number of requests from the client for other contents, in particular page elements, which are requested by the page. These elements are independently from each other collected by the server and transferred to the client. Thus, a single request for a page from the client can result in a number of additional requests for page elements from the client, so that the server receives a number of requests and sends a number of items to the client, all initiated by a single request from the client for a page without the server knowing about any relation there might exist between the requests and associated contents.

WO00/55779 describes a billing on a per page basis. The per page billing operates with a page counter. The page. counter is set at each completed page downloaded from an instruction received from the browsed site.

Since the server cannot make a difference between a page and a page element, the server cannot determine how many pages are requested by the client. Also, the server cannot determine which pages have been sent to the client completely, including all page elements. Therefore; it is not possible to charge the client on a per page basis. Also, it is not possible to assure, when a client requests for a page, that all elements are indeed transferred to the user, because the server cannot determine which items belong together and form a complete page, so that, in case that an item cannot be retrieved, the server does not know whether this results in an incomplete page. In case of a charging on a per page basis, this might result in the situation that the page is transmitted to the client but with one of the page elements unretrievable, thus resulting in an incomplete page. This means that part of the information is transmitted to the client, which may have involved transfer-time and/or transfer-cost, while the page appears to be incomplete and therefore possibly of no use for a user of the client. It is considered improper to charge a user in part or full when the server provides a failing page on the user's request., The problems outlined. above will even be more severe in case that the terminal is a mobile device, such as a mobile telephone which is connected to the server via a mobile, wireless network. In this case, the client may comprise a small display, which impedes displaying of pages, such as internet pages, which can have a large amount of text, high resolution pictures, scripts or other program modules which cannot be displayed on the display of the client. Also, in this case the bandwidth for-transferring data to and from the client is limited and expensive, so that transferring a large page, such as an internet page including all kind of page elements could easily exceed time limits and/or cost limits which are considered acceptable by a user without the user being able to put a hold on it in advance.

Within the scope of this document, a server can comprise a computer, a proxy server, a gateway or any other device which is able to, upon receiving a request, perform an operation and send data to a client. Also, the server can comprise a plurality of servers, which each perform a part of the server functionality.

Further, within the scope of this document, a page can comprise an internet page, intranet page, or any kind of data which comprises information to be presented in whatever way to a user. The page elements can comprise any kind of information, such as pictures, scripts or other software modules, audio-, video- or multimedia content, or one or more other pages.

Further, within the scope of this document, a client can comprise a computer, notebook, terminal, pocket computer, personal digital assistant, wired or mobile telephone, or any other device which is able to receive a page.

The invention intends to take away the problems of the prior art.

To achieve these and other goals, the method according to the invention is characterized in that it comprises the further steps carried out in the first server of deriving from the page the at least one request for the page element, collecting the at least one page element, in response to the at least one request for the page element derived from the page, combining the at least one page element with the page, and transferring the page with the collected at least one page element to the client. By deriving the requests for page elements from the page and collecting all page elements in the server, a combination of a page with all page elements requested by the page can be transferred to the client at once. This enables the server to charge the client on a per page basis, so that the client pays for example a fixed amount for each page that has been transferred to the client. Also, it is made possible to only transfer complete pages to a client. In case that a page element is missing, cannot be retrieved, or the request for the page element appears to be invalid, the server cannot collect all page elements and therefore cannot combine all page elements with the page, and thus no completed page can be and will be sent to the client. Therefore, the client is not charged for the transfer of a page which appears to be incomplete and consequently of little use for the client, thus reducing costs and/or time spent by the client.

The step of collecting the page and/or the at least one page element can comprise the step of transferring a request for the page and/or the at least one page element by the first server to a second server. In this way the server can retrieve pages which are located on another server.

Alternatively, the step of collecting the page and/or the at least one page element comprises the step of checking if the page and/or the at least one page element is contained in a memory, which is accessible for the first server, and transferring a request for the page and/or page element by the first server to a second server, if the page and/or the at least one page element is not contained in the memory. By making use of a memory which is accessible for the first server, pages and/or page elements which are frequently requested by one or more clients can be locally stored in such memory at the first server. This reduces the access time for the client. Also, each page and/or page element available in the memory does not need to be retrieved from another server, and thus reduces the load on a connection between the servers.

Advantageously, the method further comprises the step of prior to transferring the page and the page element integrated therewith from the first server to the client, converting the page with the collected at least one page element into a predetermined format. The predetermined format can be an at least partly compressed format. It may also have a predetermined maximum file size, it could also be defined for the client in a table comprised in the first server. In addition it can be demanded by the client by transferring a message from the client to the first server.

Advantageously, the page including a collected at least one page element is converted into a file format which is suitable, in particular most suitable, for the client.

By removing the requests for the page element from the page, it is prevented that useless information is transferred to the client, because the page elements are already integrated with the page, and it is prevented that the client sends requests for these page elements to the server.

In case that the client is equipped with a little, low resolution display, or in case that the client is coupled to the first server via a connection having a low transmission speed, an at least partly compressed format or a format having a predetermined maximum file size is very advantageous, because it avoids the transfer of large amounts of data which either cannot be displayed by the client because of a limited display device, or which would require a long time for transferring the page with the collected at least one page element to the client. The advantages are significant because they enable such clients to obtain access to large or complex pages in an efficient, easy and fast way.

Also it is possible that the client determines the format in which to transfer the page and the connected at least one page element, by transferring a message to the first server before receiving the page, or by means of a value which is stored in a table in the first server. This makes it possible to provide a certain freedom for the client to select a particular format, and thus enabling the client to determine if, for example, a high resolution, high quality page is required, or if a low resolution, but fast transferable page is required instead.

Advantageously the method comprises the further steps of transferring a message to the client comprising a quantity which provides a measure for the cost of transferring the page and the at least one page element to the client, and transferring the page with the collected at least one page element to the client, dependent on a response from the client on the message containing the quantity. In this manner, the client receives an indication of the cost for transferring the page including the page elements, prior to receiving the page, and the client can determine whether or not to receive the page, so that in case that transferring the page exceeds a certain cost or time limit, the client can prevent the first server from transferring the page including page elements, thus avoiding unnecessary costs, use of network capacity and time.

The quantity can comprise the size of the page with the collected at least one page element, or the estimated time for transferring the page with the collected at least one page element to the client, or the total charges for transferring the page with the collected at least one page element to the client.

The determination whether or not to receive the page can be made by a user of the client, but can also be performed by the client automatically, for example, by setting the maximum cost to a certain level, so that only pages having a cost for transferring which is below this level are enabled to be transferred to the client.

Advantageously, the method comprises the further steps of transferring a message from the first server to the client, comprising a statement that a page requested appears to be incomplete, and transferring a message from the client to the first server which determines whether or not to enable the first server to transfer the incomplete page to the client. Thus, in case that the client has received a message from the server because the request for the page is invalid, the page is incomplete, or one of the page elements cannot be retrieved, the client or a user-of the client can determine whether or not to transfer (part of) the page and/or (part of the) page elements from the first server to the client. In this way, unnecessary costs, use of network capacity and time associated with the transfer of an incomplete or long file can be avoided, however enabling the client to obtain part of the page, if desired.

The first server can transfer a message to a charging system for charging the client for each page transferred to the client. As the method according to the invention enables charging on a per page basis, a message can be sent for each page which has been transferred to the client, to a charging system for example by charging a fixed cost for each page, or by charging for a page depending on one or more parameters, such as file size, time required for transferring the page to the client, or other parameters.

The request for transferring the page to the client can be generated by the client, by the first server, or by another computer. In this way it is not only possible that the client sends a request for the page to the server, but it is also possible to initiate the sending of the page from the server, or from another computer, so that messages can for example be broadcasted to the client.

The first server can be coupled to the second server via a network of computers. The page can comprise an hypertext mark-up language page. In this way pages, such as internet pages comprising large amounts of data in various kinds of page elements, such as pictures, animations, video- and/or audio content, or scripts or other modules can be transferred to the client in an advantageous way.

In case that the first server is coupled to the client via a telecommunications network, such as a mobile telecommunication network or a wired telecommunication network, or any other type of network which has restricted capacity, the advantages of the invention are significant because in this way the invention enables devices such as mobile telephones, personal digital assistants, or other devices having limited display capacity to be supplied with pages from the internet most effectively. Therefore, according to the invention, these devices do not require pages written in a specific format, such as a Wireless Application Protocol (WAP) format, but are able to read any content from the internet.

Further, the invention comprises a computer program comprising program instructions for causing a server, which is coupled to a client, to perform the method according to the invention, and a computer program comprising program instructions for causing a client, which is coupled to a server, to perform the method according to the invention.

The computer programs can be embodied on a record medium, such as a CD-ROM or a magnetic medium, they can be stored in a computer memory, or can be carried on a carrier signal, such as an electrical or optical carrier signal..

Further, the invention comprises a server adapted for carrying out the method according to the invention and a client adapted to receive a page according to the method according to the invention.

The client can comprise a mobile telephone, a personal computer or a personal digital assistant, or other devices.

Still further, the invention comprises a use of a client for receiving a page from a first server according to the method of the invention, and a use of a server for transmitting a page to a client according to the method of the invention.

Within the scope of the invention the client and the first server can reside in the same geographical area, such as a country. Alternatively, it is possible within the scope of the invention that the client and the server are located in more remote locations or in different area's. The client can be coupled to the first server in a direct way, or alternatively the client can be coupled to the first server via at least or another server or a chain of servers or other computers forming part of a network, in which case each request from the client for a page is directed via the other server or the other computers towards the first server. Also, in this case each page or each message to be transferred to the client is transferred via the at least one other server or via the network. This makes it possible for a client to obtain access to pages according to the method of the invention, even if the first server is a remote server, positioned in the same or in another geographical area.

Thus, the invention enables an advantageous way of transferring a page to a client, by deriving requests for page elements from the page in the first server, collecting all the page elements, and sending a combined page, which includes the collected page element to the client.

Further features and advantages will become clear from the appended drawings, illustrating a non-limiting embodiment of the invention, in which:

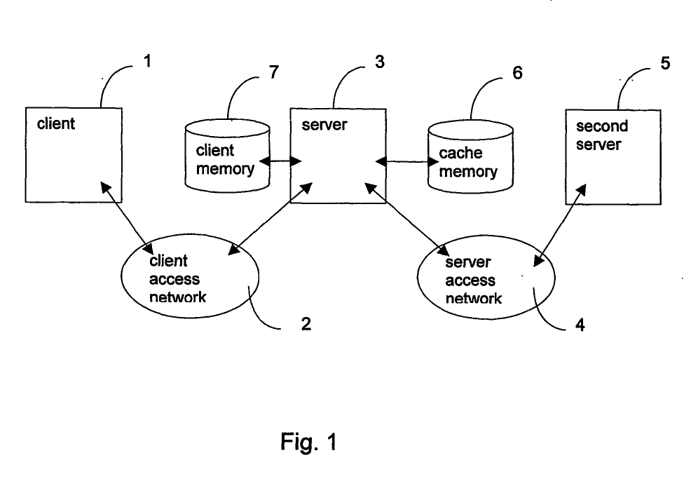

FIG. 1 shows a block schematic diagram of a client coupled to a server for transmitting a page to the client according to the invention.

FIG. 1 shows a client 1 which has access to a server 3, which may be a proxy server, via a client access network 2. The client access network 2 can comprise a telecommunication network and/or a computer network. The server 3 is coupled via a server access network 4 to a second server 5, which contains pages, such as internet pages, and page elements, such as pictures.

When the client 1 requests for a page, a request is transferred from the client 1, via the client access network 2 to the proxy server 3. The proxy server 3 first checks if the page is available in a cache memory 6 of the server 3, and if not the server 3 sends a request for the page to the server 5 via the server access network 4. This is followed by transmitting the page from the second server 5 via the server access network 4 to the server 3. Then, the server 3 determines from the page if the page comprises one or more page elements. If this is the case, the server 3 first checks in the cache memory 6 for each page element if it is present in this cache memory 6, and if not, a respective request for the page element is sent to the second server 5 via the server access network 4. This is followed by a transfer of the page elements from the second server 5 via the server access network 4 to the server 3. Then, the server 3 checks in a client memory 7 for the presence of settings which relate to the client 1. Based on these settings, the server 3 determines a maximum file size for the page and/or for the page elements, such as a maximum resolution for pictures comprised in the page. Then, the server 3, if required, reduces a resolution of a picture which forms an element of the page, or performs any other is operation required, for example by transforming the page and/or at least one the page element into an other file format, and then the page is transferred from the server 3 via the client access network 2 to the client 1.

As the server 3 can determine the relation between pages and page elements, the server 3 is able determine the number of pages requested by the client 1, and therefore it is possible to charge the client 1 per page requested by or transferred to the client 1.

Also it is possible that, prior to transferring the page and the page elements to the client 1, the server 3 sends a message to the client I providing a measure for the cost of transferring the page to the client 1, and/or providing an indication if the page is complete. Either based on this information, or anyhow, the client 1 can send a message to the server 3, which message can determine whether or not to transfer the page and the page elements to the client 1, also this message can provide a preferred file size or maximum file size, a file format and/or a maximum cost for transferring the page and the page elements to the client 1.

Further it is possible that the server 3 is coupled, next to being coupled to the second server 5, to other servers, for example via a network. In this case, the pages and/or page elements can be retrieved from the various servers, i.e. a page and all page elements requested by this page can be located on the same server, but also it is possible that the and the page elements are located on different servers. In this case, the server 3 sends a request for each page and each page element to the respective server on which the respective page and/or page element is located.

The client access network 2 can comprise all kinds of networks, such as an intranet, a virtual private network, a wireless and/or wired telecommunication network, an internet, or a combination of any of these networks.

Thus, the invention provides any information comprised in pages to a client, by first deriving the requests for page elements from the page in a server, collecting all page elements and combining the page elements with the page, and then transferring the page including the collected page elements to the client. This does not only provide a possibility for charging the client on a per page basis, and assures that any page transferred to the client is a complete page that includes all page elements, but also, most importantly, the invention makes it possible for any device, even with limited capabilities, such as a mobile telephone, or a personal digital assistant, or any other device that has comparatively limited capabilities, to obtain access to all pages on a network, such as the internet. Because the page and page elements can be converted into a predetermined format, it is made possible to adapt the page as well as the page elements to the specific requirements for the client, so that small memory content, a small display having low resolution, a low transmission capacity for transmitting the page and page elements to the client, or any other limitation which would impede or complicate the transfer, use or readout of the page in the client, can be coped with, so that all types of clients can have access to any information available on or via the server.

1. A method for transferring a page to a client which is coupled to a first server, the page comprising at least one request for a page element, comprising the step of:
collecting the page comprising at least one request for a page element in the first server, in response to a request for transferring the page to the client;
deriving in the first server from the page the at least one request for the page element;
collecting the at least one page element in the first server, in response to the at least one request for the page element derived from the page;
combining in the first server the at least one page element with the page;
transferring the page with the collected at least one page element to the client; and
charging the client on a basis of the page with the collected at least one page element transferred to the client.

2. The method according to claim 1, wherein the step of collecting the page comprises the step of:
transferring a request for the page by the first server to a second server.

3. The method according to claim 1, wherein the step of collecting the page comprises the steps of;
checking if the page is stored in a memory, which is accessible for the first server; and
transferring a request for the page and/or page element by the first server to a second server, if the page and/or the at least one page element is not stored in the memory.

4. The method according to claim 1, further comprising the step of:
prior to transferring the page with the collected at least one page element from the first server to the client, converting the page with the collected at least one page element into a predetermined format.

5. The method according to claim 4, wherein the step of converting the page into the predetermined format comprises the step of removing the at least one request for a page element from the page.

6. The method according to claim 4, wherein the predetermined format is an at least partly compressed format.

7. The method according to claim 4, wherein the predetermined format comprises a predetermined maximum file size.

8. The method according to claim 4, wherein the predetermined format is defined for the client in a table comprised in the first server.

9. The method according to claim 4, wherein the format is determined by the client by transferring a message from the client to the first server.

10. The method according to claim 1, comprising the further steps of:
transferring a message to the client comprising a quantity which provides a measure for the costs of transferring the page and the at least one page element to the client, prior to transferring the page with the collected at least one page element to the client.

11. The method according to claim 10, comprising the further step of:
transferring a message from the client to the first server which determines whether or not to enable the first server to transfer the page and the collected at least one page element to the client in response to the message comprising the quantity.

12. The method according to claim 10, wherein the quantity comprises the size of the page and with the collected at least one page element.

13. The method according to claim 10, wherein the quantity comprises the estimated time for transferring the page with the collected at least one page element to the client.

14. The method according to claim 10, wherein the quantity comprises the total call charges for transferring the page and with the collected at least one page element.

15-16. (Cancelled)

17. The method according to claim 1, wherein the request for transferring the page to the client is generated by the first server.

18-19. (Cancelled)

20. The method according to claim 1 wherein the page comprises an hypertext mark-up language page.

21-33. (Cancelled)

34. A system for transferring a page to a client within a communication system including a first server, wherein said page further includes at least one request for a page element, comprising:
means for collecting the page comprising at least one request for a page element in the first server, in response to a request for transferring the page to the client;
means for deriving in the first server the page the at least one request for the page element;
means for collecting the at least one page element in the first server, in response to the at least one request for the page element derived from the page;
means for combining in the first server the at least one page element with the page;
means for transferring the page with the collected at least one page element to the client; and
means for charging the client on a basis of the page with the collected at least one page element transferred to the client.

35. The system of claim 34, wherein said means for collecting the page further comprises means for transferring a request for the page by the first server to a second server.

36. The system of claim 34 further comprising, prior to transferring the page with the collected at least one page element from the first server to the client, means for converting the page with the collected at least one page element into a predetermined format.

37. The system of claim 36 wherein said means for converting the page into the predetermined format further comprises means for removing the at least one request for a page element from the page.
